(19) United States
(12) Patent Application Publication
(10) Pub. No.: US 2018/0074084 A1
(43) Pub. Date: Mar. 15, 2018

(54) BENCHTOP LABORATORY APPARATUS AUTOMATION SYSTEM

(71) Applicant: ESI Source Solutions, LLC, Woburn, MA (US)

(72) Inventor: John Neveu, Woburn, MA (US)

(21) Appl. No.: 15/698,969

(22) Filed: Sep. 8, 2017

Related U.S. Application Data
(60) Provisional application No. 62/393,046, filed on Sep. 11, 2016.

(51) Int. Cl. G01N 35/00; B01L 1/00; B01L 9/00; B01L 3/00; B01L 7/00; B01L 9/02

(52) U.S. Cl. CPC G01N 35/00722; B01L 1/50; B01L 9/543; B01L 3/523; B01L 7/00; B01L 9/02; G01N 2035/00346; B01L 2200/08; B01L 2300/046; B01L 2200/143; G01N 2035/00277; G01N 2035/00287; G01N 2035/00306; B01L 2200/141

(57) ABSTRACT

The Benchtop Laboratory Apparatus Automation System, hereafter referred to as BLAAS, is designed for automation of common laboratory benchtop devices such as pipette tip boxes, waste containers, sample tubes and trays, and reagent or solvent containers. The BLAAS consists of a microprocessor, sensor and physical actuator attached to the benchtop device. A user's hand approaching the device will be detected and the system will respond by opening the device, allowing hands-free access to the contents. After a short delay, the top closes again after the hand clears the device. A light will illuminate to indicate when the device is actively opening, and parameters like the speed of the movement, the stop positions of the servo and the time the device remains open can be adjusted.

This application claims priority from U.S. Provisional Application No. 62/393,046, filed on Sep. 11, 2016, the entire contents of which is incorporated herein by reference.

### FIELD

Aspects of the present application relate to a semi-automated benchtop workspace for biological, chemical or clinical analyses.

### BACKGROUND

Modern scientific researchers worldwide use manually operated laboratory benchtop devices like pipette tips boxes, and various sample and reagent tubes, bottles or containers in their daily workflows, and frequently they spend hours a day at the laboratory bench performing detailed technical procedures and protocols using these devices. These devices typically have lids or covers to keep the contents from being contaminated and retain their chemical or biological integrity. Generally, these benchtop devices require the researcher to use both hands to access the contents, causing repeated interruptions in the smooth processing of the samples or protocol workflow, often leading to errors and loss of sample integrity.

Medical, chemical, clinical and academic researchers worldwide depend on manually operated benchtop laboratory apparatus to accomplish their sample processing or protocol goals. Common devices and apparatus on the benchtop include handheld manual volumetric pipettors and their pipette tip racks or refillable boxes, racks of tubes for samples and reagents of diverse sizes, volumes and shapes for specific purposes which can be kept at various temperatures on the benchtop by use of ice buckets or cooling or heating blocks, boxes for bulk tubes or pipette tips, waste containers for used tips and tubes as well as numerous other protocol-specific accessories and hardware. Using these devices and apparatus is a manual process, generally requiring both hands of the operator to open the top of a box or tube or rack of samples to gain access to the contents. This makes a protocol workflow which is already tedious and repetitive even more challenging, as the interruptions can lead to spilled samples or loss of concentration by the operator, causing errors in otherwise exacting scientific protocols or workflows. Most benchtop laboratory apparatus are covered to reduce contamination from interfering with the protocol or to retain biological activity of a reagent or sample for the protocol. It is a frequent practice for a busy chemist to simply leave the box of pipette tips or reagent bottles or sample tubes open instead of repeatedly opening and closing each container during the workflow, potentially compromising the integrity of the protocols they are doing due to contamination of the sample or reagents by exposure to air or dust or biological or chemical substances. As these benchtop apparatuses currently lack automation, adding BLAAS to them can dramatically improve workflow throughput, efficiency and reliability while reducing some of the causes for repetitive stress induced injuries in the workplace as well as reducing potential contamination of the protocol components. Full implementation across a given workspace will lead to a semi-automated workstation for biological, tissue culture, chemical or clinical protocols and research that will become the new standard for laboratory benchtop workspaces.

Implementing Benchtop Laboratory Apparatus Automation System (“BLAAS”) across the whole laboratory benchtop will allow customizable high efficiency workflows to be established, improving efficiency and reproducibility across protocols or sample sets, leading to a semi-automated benchtop workspace for biological, chemical or clinical analyses.

### SUMMARY

Aspects of the present application are directed to a unique adaptation of simple electronics to benchtop laboratory apparatus, capable of automating the opening and closing of boxes, tubes, containers and other objects from a wide number of popular vendors and suppliers.

In certain aspects of the application, BLAAS uses a sensor to detect an operator approaching the device, and sends a signal to the programmable microprocessor to activate a mechanical actuator (or other) to open device, allowing the operator access to the contents of the box or tube(s) in a hands-free manner. In certain embodiments, a benchtop laboratory apparatus automated system comprising: a benchtop laboratory apparatus with a cover, wherein the laboratory apparatus is connected to an automated system; a power input into the automated system; a programmable control board, wherein the programmable control board controls the automated system; a sensor, wherein the sensor detects a signal present near the apparatus; a physical actuator, wherein the physical actuator shifts between a first position and second position; a mechanical linkage, wherein the mechanical linkage links the shift in the physical actuator from the first position to the second position to the cover of the laboratory apparatus, and further wherein in the first position the cover of the laboratory apparatus is closed and in the second position the cover of the laboratory apparatus is open; and an electronic network, wherein the electronic network communicates between the sensor and the programmable control board and the physical actuator whenever the signal is present near the apparatus, and wherein when the programmable control board receives a communication from the sensor that the signal is present near the apparatus then the programmable control board instructs the physical actuator to shift from the first position to the second position. In a particular embodiment, the automated system further comprises: a light source, wherein the light source illuminates during the operation of the automated system when the physical actuator shifts from the first position to the second position. In some embodiments, the physical actuator is a rotary servo, a linear actuator, a pneumatic control or a magnetic control. In certain embodiments, the benchtop laboratory apparatus is a refillable pipet tip box, a reagent tube or a waste disposal unit.

In certain embodiments, the mechanical linkage is a double action spring mechanism. In particular embodiments, the rotary servo is connected to a double action spring mechanism, and wherein the double action spring mechanism comprises: a rigid plastic device, wherein the device fits onto the output splines of the rotary servo; a servo control arm, wherein the servo control arm is formed by the fitted rigid plastic device, and further wherein the servo control arm comprises a base containing a groove; a coiled spring, wherein one arm of the spring is immobilized within the groove of the servo control arm and the other arm of the spring is extending out; and a tubular extension centered over the rotary servo splines, wherein the tubular extension comprises a top that holds the coiled spring in place, wherein the coiled spring is installed around the tubular extension.

In another aspect of the application, BLAAS improves operator efficiency for a given workflow, as the operator does not have to put things down to use both hands to open a sample or reagent tube or container, like a box of disposable pipet tips or a rack of covered sample vials or a 96 well plate. In another embodiment, the automated system further comprises: a light source, wherein the light source illuminates the benchtop laboratory apparatus during the operation of the automated system when the physical actuator shifts from the first position to the second position.

In aspects of the application, BLAAS can be contained in an external housing which holds components together, or can be miniaturized to fit inside the device case itself. A custom electronic board under development is much smaller than the microprocessor used in development. In a particular embodiment, the automated system further comprises: an external case, wherein the automated system is integrated with the external case before and during operation of the automated system, and further wherein the benchtop laboratory apparatus can be separately removed from the external case and the automated system. In a specific embodiment, the automated system further comprises: a light source, wherein the light source illuminates the benchtop laboratory apparatus during the operation of the automated system when the physical actuator shifts from the first position to the second position, and further wherein the light source is positioned within the external case underneath the benchtop laboratory apparatus. In particular embodiments, the external case further comprises an inner thermal liner, wherein the thermal liner can either heat or cool the benchtop laboratory apparatus.

In other aspects of the application, BLAAS can be contained in an external housing which holds components together, or can be miniaturized to fit inside the device case itself. In a particular embodiment, the automated system is integrated with the benchtop laboratory apparatus before and during operation of the automated system. In certain embodiments, the automated system further comprises an inner liner, wherein the inner liner permits air circulation within the benchtop laboratory apparatus.

An aspect of the application is a method of opening a benchtop laboratory apparatus using an automated system comprising the steps of: sensing a signal present near a sensor, wherein the sensor detects the presence of the signal, and further wherein the sensor is part of an automated system comprising a benchtop laboratory apparatus with a cover; communicating the presence of the signal from the sensor to a programmable control board; instructing a physical actuator to shift from a first position to a second position, wherein the physical actuator is instructed by the programmable control board after the sensor has communicated to the programmable control board the presence of the signal; shifting the physical actuator from a first position to a second position; moving a mechanical linkage that is connected to the physical actuator, wherein the mechanical linkage physically transmits the shift from the first position to the second position to the cover of the benchtop laboratory apparatus; and wherein the shift of the physical actuator from the first position to the second position corresponds to a shift from a closed cover to an open cover of the benchtop laboratory apparatus. In certain embodiments, the method further comprises the step of: instructing the physical actuator to shift from the second position back to the first position after a period of time when the sensor no longer detects the presence of the signal. In other embodiments, the method comprises the step of: illuminating the benchtop laboratory apparatus during the shift from the first position to the second position, and wherein the illumination is maintained until the physical actuator is instructed to shift from the second position back to the first position.

These and other aspects and embodiments of the present application will become better understood with reference to the following detailed description when considered in association with the accompanying drawings and claims.

### BRIEF DESCRIPTION OF THE DRAWINGS

FIG. 1 shows an exemplary basic schematic of the Benchtop Laboratory Apparatus Automation System, of BLAAS. The major components are a power input, the microprocessor, a sensor, a servo and an LED.

FIG. 2 shows an exemplary embodiment of BLAAS where when activated by triggering the sensor, the microprocessor controls the servo as it moves from Position A to Position B and the LED turns on.

FIG. 3 shows an exemplary embodiment of BLAAS where when activated by triggering the sensor, the microprocessor controls the linear actuator as it moves from Position A to Position B and the LED turns on.

FIG. 4 shows an exemplary embodiment of BLAAS implemented using an Arduino UNO R3. This is the detailed wiring diagram of a BLAAS system full operational using a popular and readily available programmable microprocessor, the Arduino UNO R3.

FIG. 5 shows an exemplary embodiment of BLAAS implementation 1 (using a servo) on pipet tip box type 1 (control horn to rear of hinge). BLAAS components are mounted in an external housing.

FIG. 6 shows an exemplary embodiment of BLAAS implementation 1 (using a servo) on pipet tip box type 2 (control horn to front of hinge).

FIG. 7 shows an exemplary embodiment of BLAAS implementation 2 (using a linear actuator) on pipet tip box type 1 (with control horn at rear of hinge).

FIG. 8 shows an exemplary embodiment of BLAAS implementation 2 (using a linear actuator) on pipet tip box type 2 (with control horn in front of hinge).

FIG. 9 shows an exemplary embodiment of BLAAS on pipet tip box type 1 with a tray of disposable pipet tips in place.

FIG. 10 shows an exemplary embodiment of BLAAS on covered tube rack in box type 1 with small sample or reagent tubes in multiple rows. Tubes from 5.0 ml to 0.1 ml in this configuration. An inner thermal liner allows cooling or heating of the samples.

FIG. 11 shows an exemplary embodiment of BLAAS on covered tray in box type 1 with 96 or 384 well plates. Well volumes vary by plate type, cool or heat liner in place.

FIG. 12 shows an exemplary embodiment of BLAAS on larger sample or reagent tubes in a rack with cap with a hinged lid. Variations of this style implementation can hold tubes from 5 to 50 ml tubes, and even larger bottles and containers.

FIG. 13 shows an exemplary embodiment of BLAAS with a front view of BLAAS installed in external housing for larger sample or reagent tubes in a rack with cap with a hinged lid. Variations of this style implementation can hold tubes from 5 to 50 ml tubes, and even larger bottles and containers. There are individual sensors for each position.

FIG. 14 shows an exemplary embodiment of BLAAS on larger sample or reagent tubes with hinged cap lid and a clear cooling chamber for temperature control. Variations of this style implementation can hold tubes from 5 to 50 ml tubes, and even larger bottles and containers.

FIG. 15 shows an exemplary embodiment of BLAAS with a front view of BLAAS installed in external housing for larger sample or reagent tubes in a rack with cap with a hinged lid with clear cooling chamber for temperature control. There are individual sensors for each position.

FIG. 16 shows an exemplary embodiment of BLAAS on table top waste container, sharps container (or other) with a hinged lid. A plastic liner for waste can be inserted in the main compartment.

FIG. 17 shows an exemplary embodiment of BLAAS using miniaturized components for a pipet tip box type 2 without external housing. Miniaturized components including a custom microprocessor, linear actuator or servo and sensor can be built directly into the housing for refillable disposable pipet tip systems.

FIG. 18 shows an exemplary embodiment of BLAAS on covered individual tubes or rows of tubes. Small servos or linear actuators can be multiplexed to open individual tubes in sequence or in rows. This configuration can be expanded upon to include containers from large bottles, medium and small tubes, and even 96 well plates.

FIG. 19 shows an exemplary embodiment of BLAAS with Custom Rotary Servo Control arm with double action spring. The Custom control arm fits on the servo outlet spline, allowing rotation of the spring to facilitate the moving the box top or tube lid the BLAAS is attached to. The double action spring allows free motion of the top or lid regardless of servo position.

FIG. 20 shows an exemplary schematic diagram of the Custom Rotary Servo Control arm with double action spring in action protecting the servo and linkage assembly from damage when the top of the box is manually moved against the servo motion.

FIG. 21 shows an exemplary embodiment of BLAAS with Custom Linear Actuator Control arm with double action spring. A similar custom spring assembly works with a linear actuator for provide force to top the box top of lid. The double action spring allows free motion of the top or lid regardless of linear actuator position.

FIG. 22 shows an exemplary schematic diagram of the Custom Linear Actuator Control with double action spring in action protecting the linear actuator and linkage assembly from damage when the top of the box is manually moved against the servo motion.

FIG. 23 shows an exemplary embodiment of BLAAS with other functional double spring mechanisms that can be used in the linkage assembly to protect the servo or actuator from damage.

FIG. 24 shows an exemplary schematic diagram of a double action spring in action mechanism protecting the linear actuator and linkage assembly from damage when the top of the box is manually moved against the servo motion.

FIG. 25 shows an exemplary schematic diagram of components of the mechanical linkage assembly as well as several possible linkage assembly configurations.

FIG. 26 shows an exemplary example of BLAAS using a flexible linkage assembly to open and close the hinged lid on larger sample or reagent tubes.

FIG. 27 shows an exemplary schematic diagram of a BLAAS system using pneumatic controls. The microprocessor controls a pneumatic manifold which controls either a positive or negative pressure to activate the pneumatic actuators and move the device.

FIG. 28 shows an exemplary schematic diagram of a BLAAS controlling multiple positions or individual devices from a single vacuum or pressure manifold using pneumatic control.

FIG. 29 shows an exemplary schematic diagram of a BLAAS system using electromagnetic actuators controlled by microprocessor.

FIG. 30 shows an exemplary schematic diagram of the BLAAS with electromagnetic actuators controlling several positions in a single device or separate devices.

FIG. 31 shows an exemplary schematic diagram of BLAAS with an external input to trigger the motion of a linear actuator.

FIG. 32 shows an exemplary embodiment of BLAAS with an adaptive external casing which can be mounted onto many types of pipet tip boxes and other containers.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described. As used in this specification and the appended claims, the singular forms “a,” “an” and “the” include plural referents unless the content clearly dictates otherwise.

As used herein the term “protocol” refers to any experimental procedures, or other research procedures, performed in or outside a laboratory for academic, industrial or commercial or non-commercial goals. The term “protocol” also encompasses non-experimental procedures that are pursued for academic, industrial or commercial or non-commercial goals and may use the aspects and embodiments of the application described herein. Such other protocols may include kitchen or other culinary protocols, such as molecular gastronomy; industrial protocols, such as testing protocols; or educational protocols, such as for instructional use. One of ordinary skill will be able to conceive various protocols in which aspects and embodiment of the application can be used.

As used herein the term “signal” refers to an operator's hand or a pipette. The term “signal” may also include the use of a hand transponder, magnet, wireless transmitter or other device. One of ordinary skill will be able to conceive various signals which can be incorporated in aspects and embodiment of the application.

The Benchtop Laboratory Apparatus Automation System (“BLAAS”) is a set of electronic and mechanical devices designed to automate common benchtop laboratory apparatus. The major components are a programmable control board which supplies power to the components and coordinates the input and output of sensor readings and servo position, a sensor to detect the presence of the operator's hand near or the distance from the device, a servo or linear actuator mechanism to provide the motion to activate the opening and closing of the cover of the apparatus via a mechanical linkage which applies the servo motion to the moving cover of the apparatus while also providing protection from physical damage to the servo and linkage via a double action spring (or other) mechanism.

The BLAAS affords the researcher access to the contents of the benchtop device such as, but not limited to, a pipette tip box, sample or reagent tubes or vials or trays, and other containers on the laboratory benchtop by using a sensor(s), programmable or dedicated control board and mechanical actuator(s) or servo(s) to open and close the benchtop device on demand in a hands-free manner. Benefits to the researcher include less interruption in the protocol workflow, reduced repetitive stress-inducing motions, reduced contamination of protocol components and improved efficiency and reproducibility at the laboratory bench.

In certain embodiments, the BLAAS is applied to a pipette tip box of a commercially available refillable pipette tip system (VWR Next Generation Tip system in this example) to allow hands-free access to pipette tips for the manual volumetric pipettors used almost universally across fields of modern chemical and biological scientific research. BLAAS can be applied to any container, tube or bottle which requires a cap be removed or top opened for the user to access the content, such as a covered tray holding sample tubes (0.2 ml, 0.35 ml, 0.5 ml, 1.5 ml or 2.0 ml tube volumes are commonly available), a larger conical capped tube (5 ml, 15 ml and 50 ml are common sizes) or other benchtop container (holding loose sample tubes or pipette tips, waste container for used tip and tubes, but not limited to) or even covered trays for 96/384 well plate format work.

An aspect of the application is designed to assist scientists, researchers and technicians working at benchtop workstations using handheld manual pipettors and other common benchtop apparatus including tubes, boxes, bottles and containers in all fields of research including commercial, academic, clinical, chemical, medical laboratories and others. The difficulty of accurately performing repetitive, exacting chemical or biological manipulations during protocols day in and day out is a serious challenge for bench-level scientists in all industries. The BLAAS system adds automation to typically manually operated benchtop apparatus, making them respond to the researcher's motions and gestures. This allows a more efficient workflow with less interruptions and potentially reduced repetitive stress inducing movements.

### BLAAS Device Components

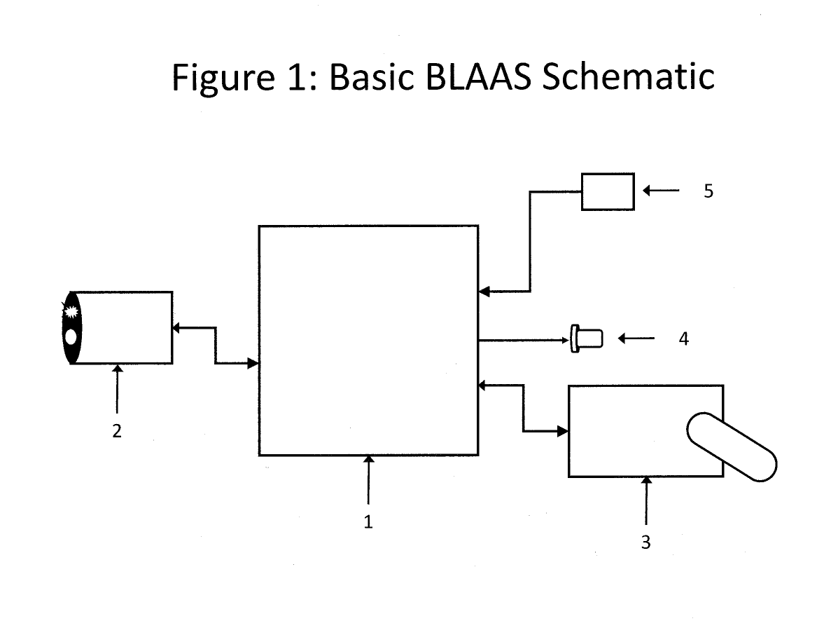

The basic components for the BLAAS are show in FIG. 1. The heart of the device is a programmable microprocessor (1) capable of distributing power to and interacting with the other components. There are many commercially available microprocessors that can be used for this purpose; one of ordinary skill will understand that the choice of programmable microprocessor is not limiting. A sensor (2) is used to detect motion or distance either by infra-red/ultra-violet or visible light, ultrasonic detection or other proximity detection mechanism; one of ordinary skill will understand that the choice of sensor is not limiting. There are hundreds of commercially available devices which can fulfill the roll of a sensor for this purpose, in the present embodiment a sealed one-piece infra-red light powered range finding sensor is used. For physical movement, a common electric servo (3) was selected from a field of hundreds which could serve the purpose; one of ordinary skill will understand that the choice of servo is not limiting. An LED light (4) is used to illuminate the device when activated, telling the user the device has been activated and to expect motion immediately. Power input is achieved via common low voltage plugs and jacks (5).

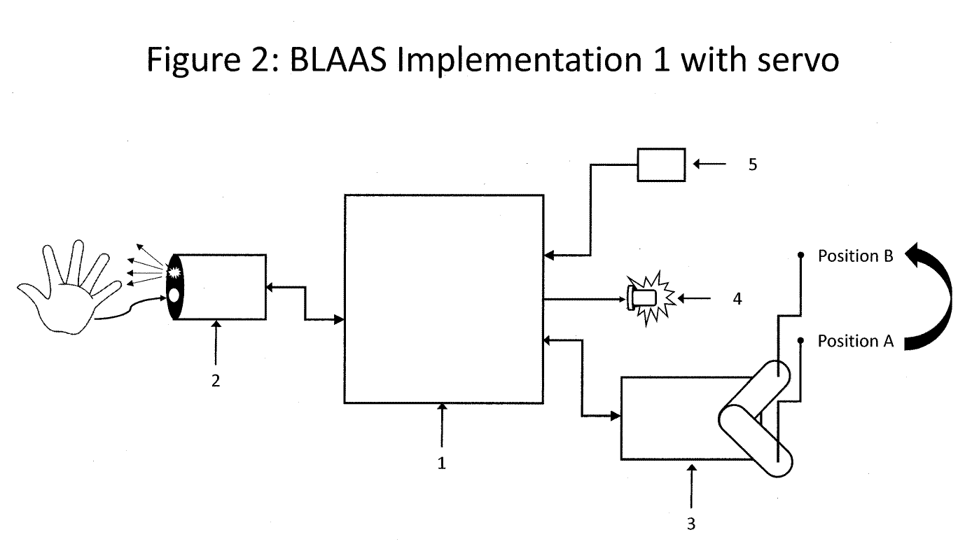

Activation of the BLAAS occurs when a hand or other object triggers the sensor, as shown on the left side of FIG. 2. The sensor sends a signal to the microprocessor, which determines if the signal from the sensor is within a user defined range of parameters (distance and time of residence for instance). If the signal is within this range, the microprocessor controls the movement of the servo using user defined parameters (speed and start/stop positions for instance) to move from Position A to Position B.

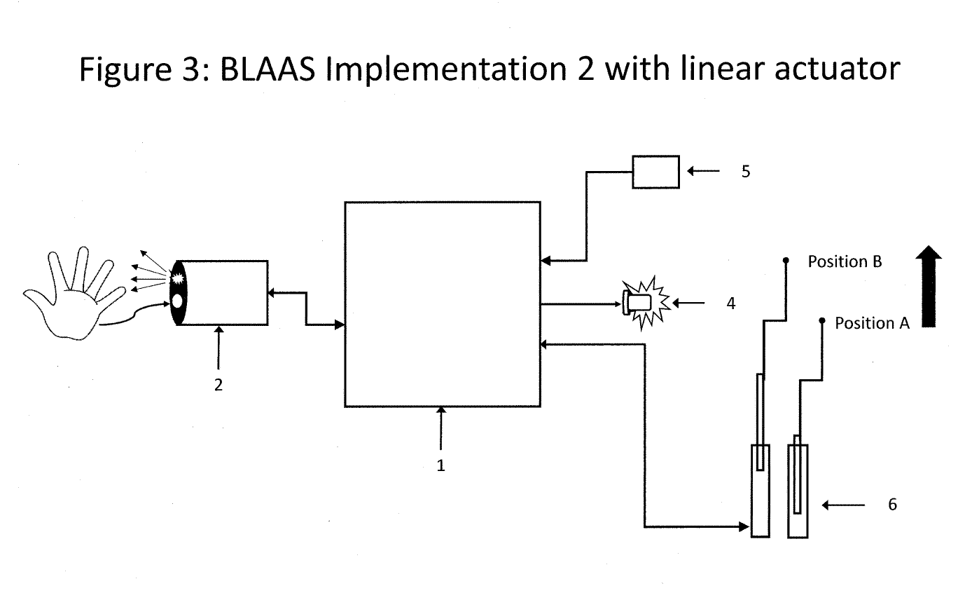

In a similar fashion, in another embodiment shown in FIG. 3 (designated BLAAS Implementation 2) alternatives such as linear actuators or solenoids or pneumatic pistons or magnetic force (6) instead of servos can be used to produce an identical effect of a movement from Position A to Position B once the sensor has been triggered.

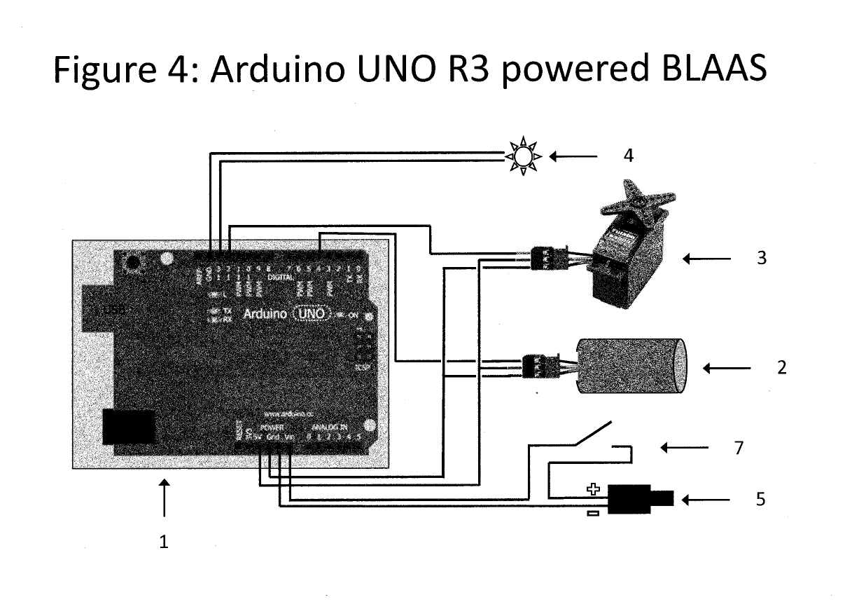

Details of the wiring diagram of the BLAAS system is shown in FIG. 4. Input power from the power jack (5) is routed through a manual Power Switch (7), which brings a positive (+) 9 VDC 1 AMP voltage to the “Yin” pin on the bottom edge of the exemplary Arduino microprocessor (1), next to two common ground pins marked “Gnd”. One of these “Gnd” pins is the negative (−) power lead, the other “Gnd” serves as the ground for negative leads for system components. The next pin is the “5V” output power lead for system components, which supplies power to the sensor (2) and servo (3) as shown. Signal from the sensor is input via the digital pin on the microprocessor, and motion and position of the servo is controlled by a separate dedicated pin on the microprocessor. These pins were set to perform these functions via a software program, which is open-access software and customizable with little needed expertise by the user. When the device has been activated by the sensor detecting something in its area, the servo moves and the LED illuminates (4) using the digital lead pin and the GND lead pin as shown until the system returns to all original positions.

In some embodiments, the microprocessor, one non-limiting example of which is the Arduino UNO has multiple digital and analog input and output leads, a power control circuit and, optionally, a USB port for uploading of programs into RAM. One of ordinary skill will understand that a dedicated circuit can be designed to save cost and reduce component footprint significantly.

### A Benchtop Device Implementation Using A Servo

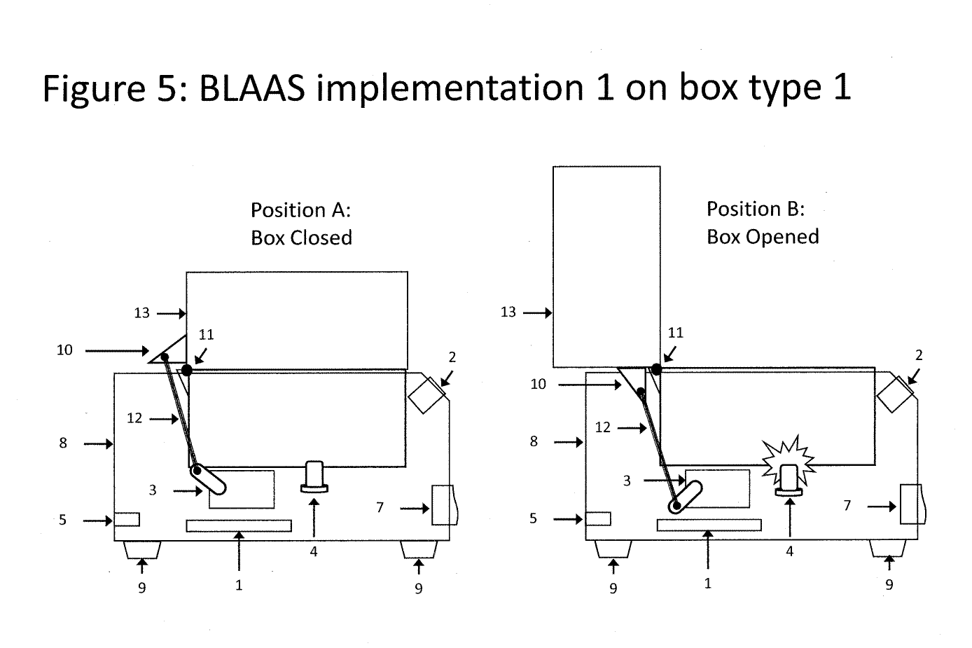

FIG. 5 shows one embodiment with the components mounted in a custom metal case or external housing (8). A mechanical servo (3) is used in this configuration, which is designated BLAAS Implementation 1. On the front panel of the housing is a slanted area which holds the sensor (2) at an angle advantageous to detecting an approaching hand or other object, between 15 and 45 degrees below horizontal from the top of the housing. Below the sensor on the lower front panel is the power switch (7) which controls power to the microprocessor (1) from the power input jack (5). This case holds in place the box, tube, rack or other container which is going to be opened by the action of the BLAAS. It also serves as a solid base to support the use of the device due to the weight of the metal external housing (in this embodiment, ˜2.5 lbs. for the case alone, ˜3.3 lbs. with BLAAS components installed) and the soft rubber feet (9) the system is designed with. Whatever the BLAAS is running, it is designed to stay in place on the lab bench until picked up and moved with purpose. This is important because most of the disposable plastic and glass tubes, tips, sample racks and other hardware are typically very light and easily displaced or knocked over on a busy benchtop.

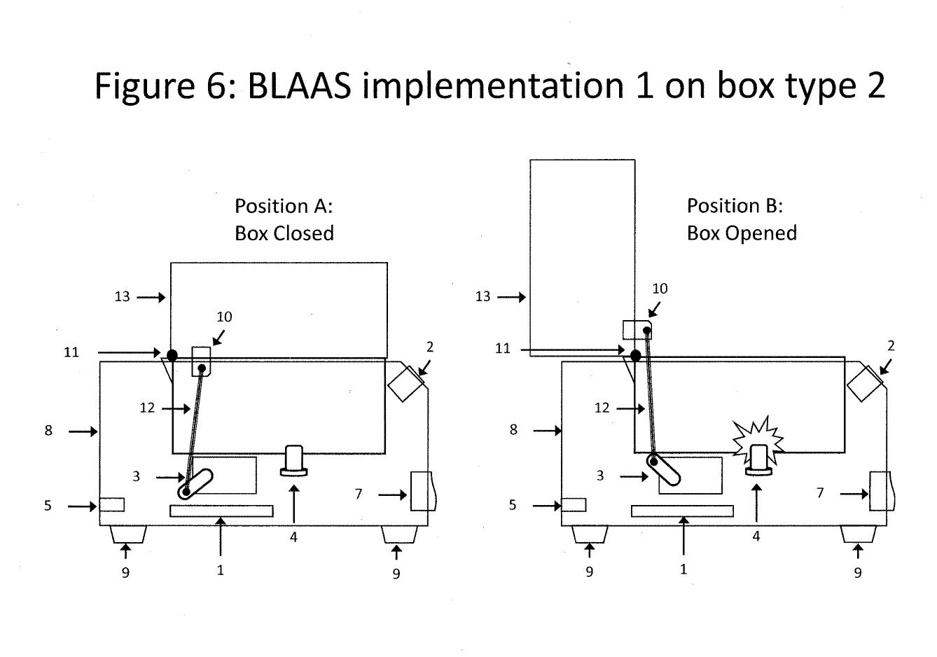

As shown in FIG. 5, the external housing is holding a box with a control horn (10) positioned behind the hinge of the lid of the box (11). This kind of box is designated herein as Box Type 1, as compared to an arrangement where the control horn is in front of the hinge of the lid of the box, which is designated herein as Box Type 2 (which is shown in FIG. 6). The choice of which configuration of BLAAS Implementation 1 works best depends on the shape of the box and internal components, but each offers full function to the operator.

On the left panel of both FIGS. 5 and 6, the servo (3) is positioned to close the top of the box (13) (referred to as Position A), and on the right panel the servo (3) has changed position to open the top of the box (referred to as Position B); the motion of the rotating arm of the servo being transmitted to the control horn (10) via a mechanical linkage (12) (such as a rod, etc). When the servo (3) begins to move, the LED light (4) is illuminated in a position underneath the box, allowing the operator easy visualization of the contents. The box will remain open as long as the operators hand remains in place to trigger the sensor (2). Once the operators hand has left the sensor range, and after a brief time determined by the user, the LED turns off and the top of the box starts to close. If at any time during the closing the operators hand again triggers the sensor, the box top will reopen and the LED will illuminate again immediately.

### A Benchtop Device Implementation Using a Linear Actuator

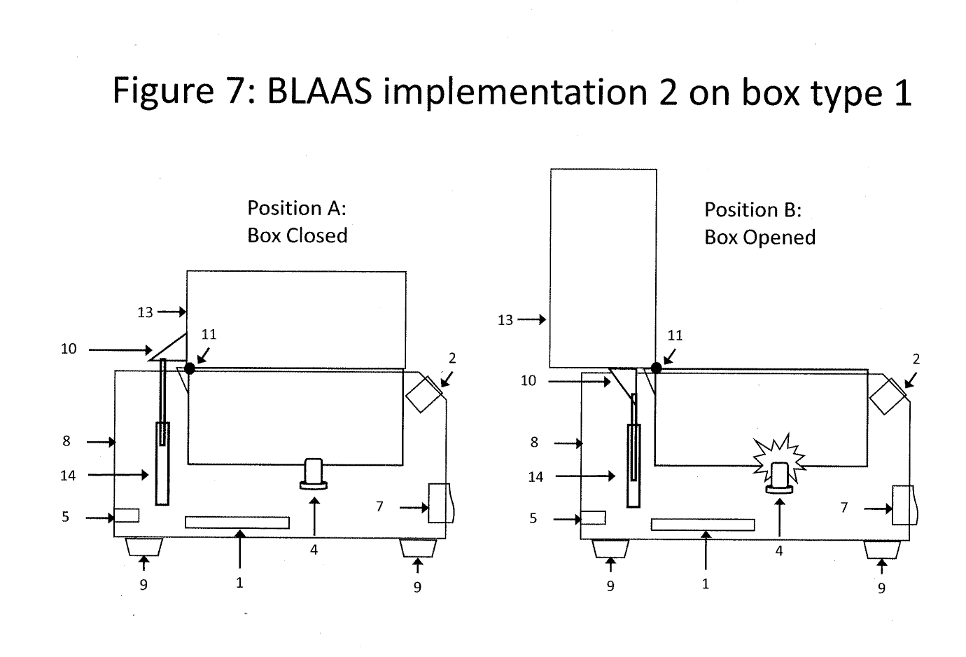

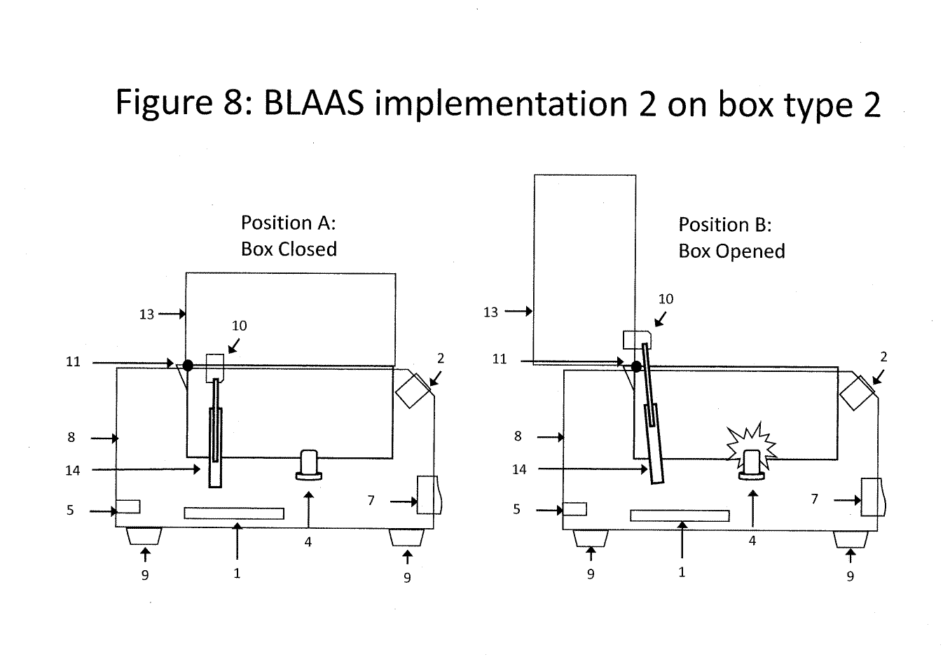

The use of a linear actuator (14) instead of a mechanical servo has certain advantages in some applications, which is designated herein as BLAAS Implementation 2. This configuration can be used in either of the described Box Types 1 and 2, as shown in FIGS. 7 and 8. Other types of mechanical actuators can be substituted for mechanical servos or linear actuators, such as but not limited to pneumatic pistons, hydraulics, magnetic or electromagnetic force, but all must produce the same effective amount of torque to move the top or lid of the device BLAAS has been fitted to from a closed (Position A) to open position (Position B).

### A Benchtop Device Implementation for a Refillable Pipet Tip Box

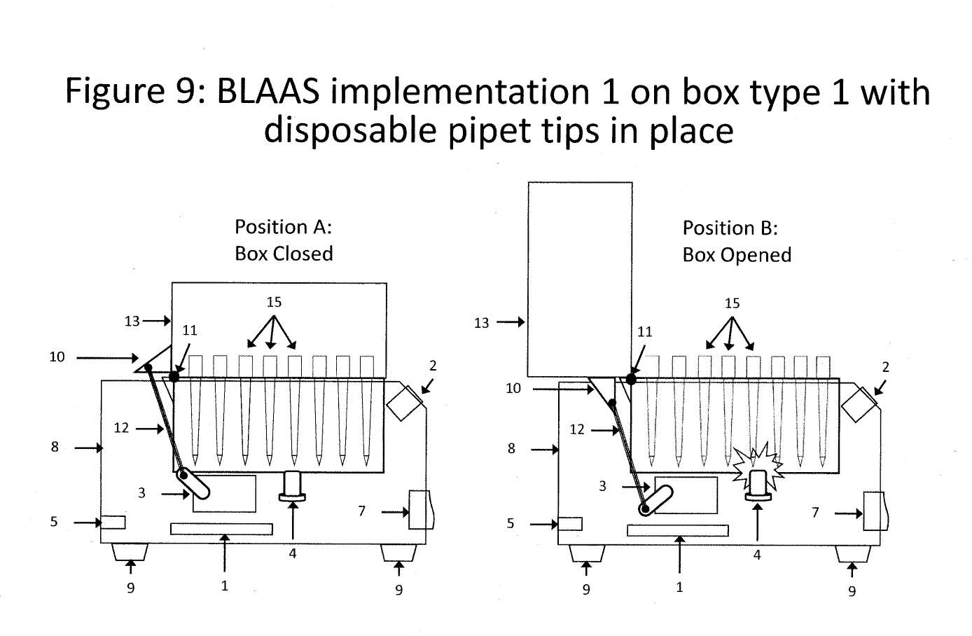

FIG. 9 shows one exemplary embodiment of the BLAAS. This configuration uses refillable pipet tip boxes from various vendors and allows easy access to disposable plastic pipet tips (15) in a hands-free fashion. These tips range in volume ranges from under a microliter to over a milliliter, and come in lose bulk packs or arranged in trays which can be readily replaced as needed. Typically, they come in 96 tip formats (8×12 rows) but other configurations are available. The first version uses a refillable pipet tip system from VWR, the Next Generation Tip system. Other vendors offer similar refillable pipet tip systems. One of ordinary skill will understand that by modifying the external housing, designing inserts or brackets and changing placement of the control mechanisms the BLAAS is capable of accommodating all of them. Functionally, this device makes a significant difference in many workflows, as the pipet tip box is a common point of struggle during a busy day at the bench. With a solid base (as provided by the case (8)), the tips are easily applied to the pipettor and spilling the box of tips (a surprisingly frequent event as the light weight box is easy to spill when withdrawing a new tip from the box, or when opening it with only one hand, or when attempting the classic “finger flip” method of trying to flip the top of the box open with one free finger to access tips) is virtually eliminated.

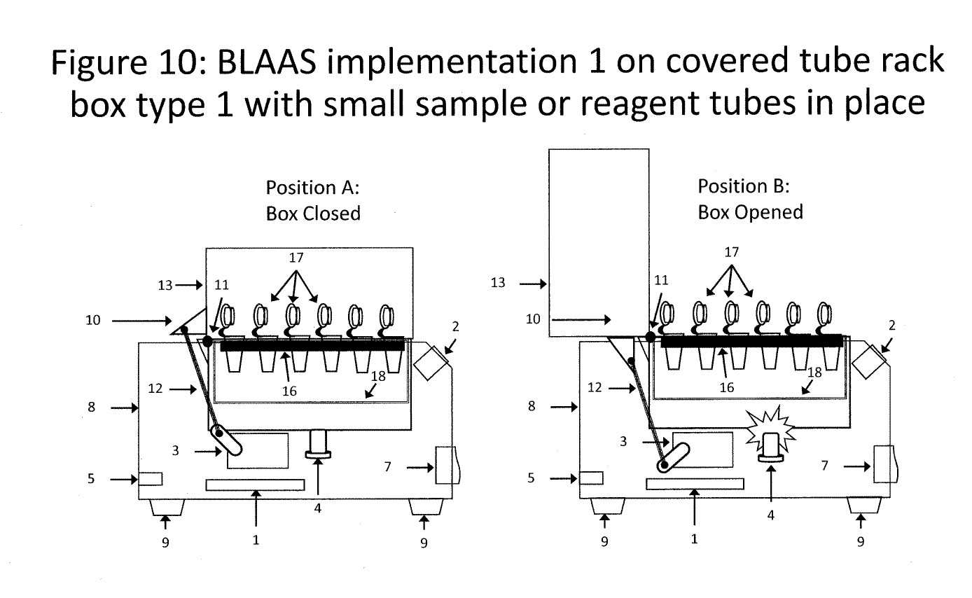

As shown in FIG. 10, in one embodiment, a modified external housing (8) or custom tray insert (16) can hold small sample or reagent tubes (17) in a single covered box. This keeps the sample or reagent tubes covered and allows less contamination from dust to enter the tubes. Various numbers of tubes can be accommodated with various volumes. In certain embodiments, with an internal thermal liner (18), the rack of tubes can be either cooled via ice, Pelletier cooling or circulating chilled water or warmed by electric heaters or circulation water (or other methods).

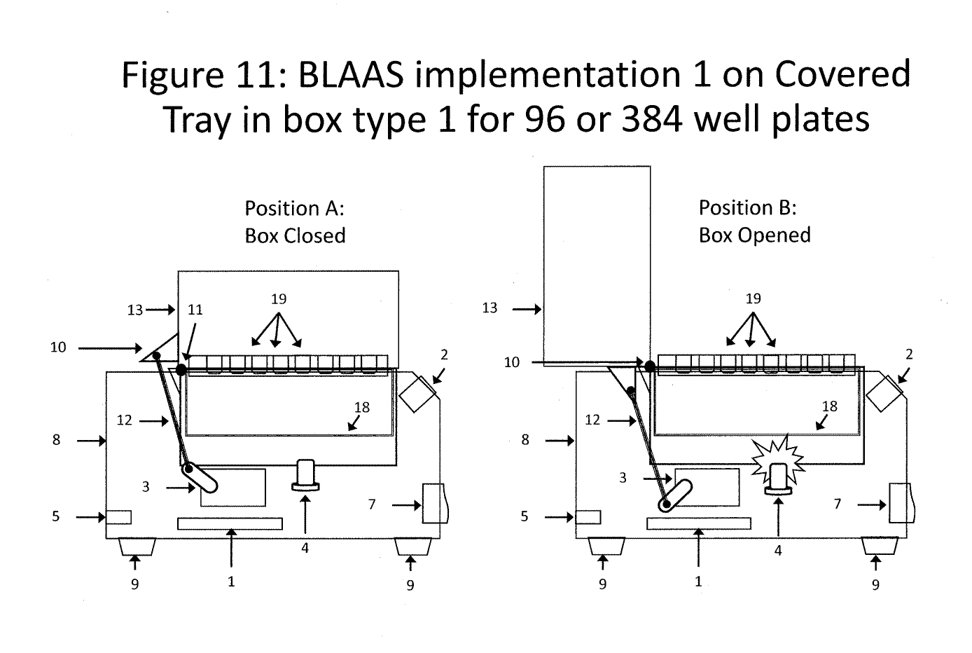

In a similar fashion, FIG. 11 shows a 96 (or 384) well plate under a single cover, with a thermally controllable compartment for optimal sample preparation conditions.

### A Benchtop Device Implementation for Large Tubes

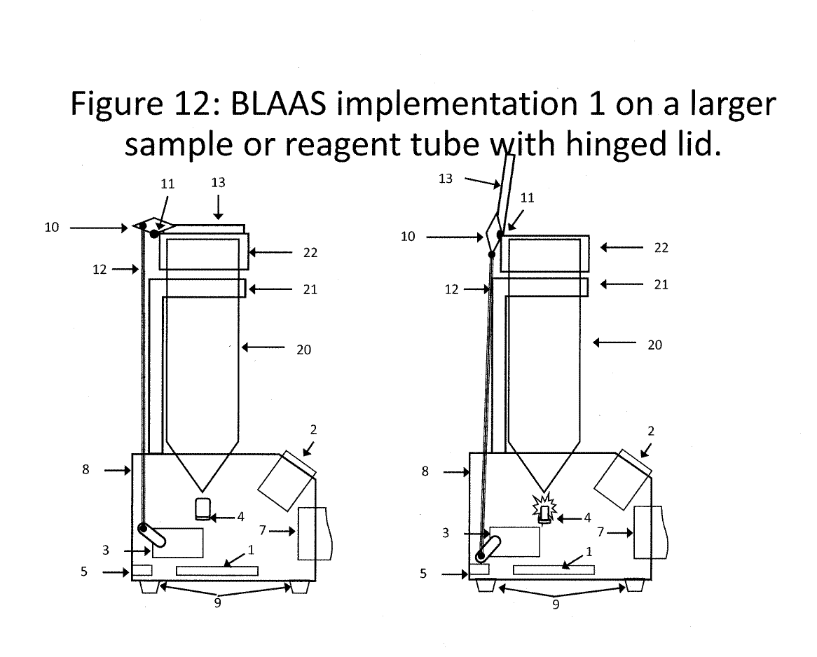

Larger tubes, as shown in FIG. 12, ranging in volumes from 5 ml to 500 ml commonly used on the benchtop are another source of distraction for the practioner, as they typically have a screw type cap which needs two hands to open and close successfully. These larger tubes (20) are usually held in racks or some type of support bracket (21), as they spill very easily even if they do not have a conical bottom as shown. In one embodiment, with the addition of a hinged cap assembly on the top of the tube (22) BLAAS can be mounted in single or multiple positions using modified external cases with the individual components mounted as shown (components numbered as in previous Figures). The right panel shows the device in the open position, with the LED illuminating the inside of the tube for easier visualization of the contents.

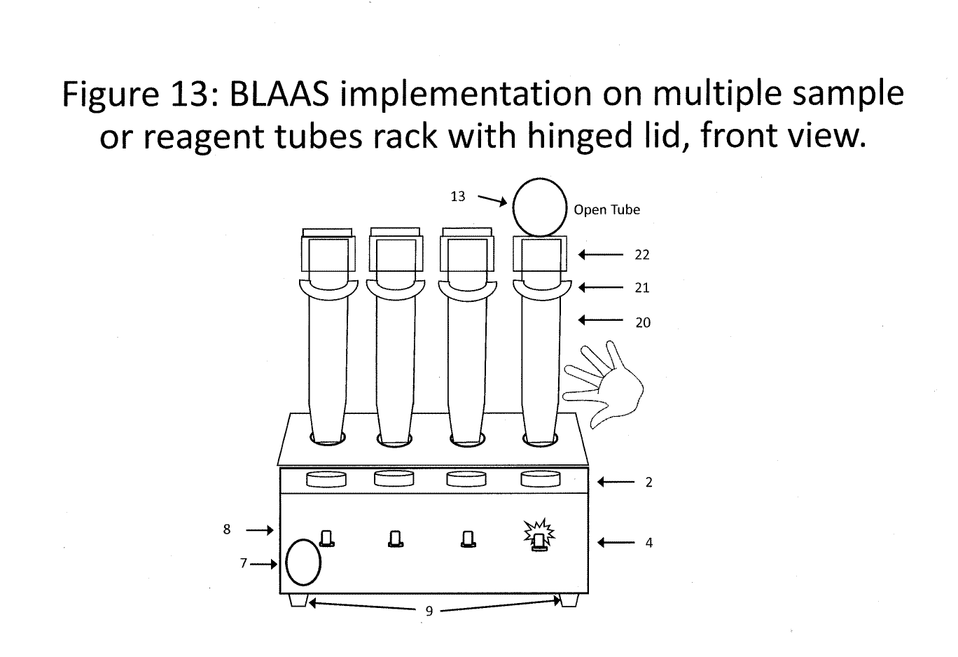

FIG. 13, shows a front view of multiple tubes in a BLAAS-enabled rack of 4 tubes. This can be configured with individual sensors at each tube position, allowing hands-free access to the content of the any of the individual tubes. Individual LED lights illuminate the contents of the tube which is triggered to open, as shown on the tube furthest to the right.

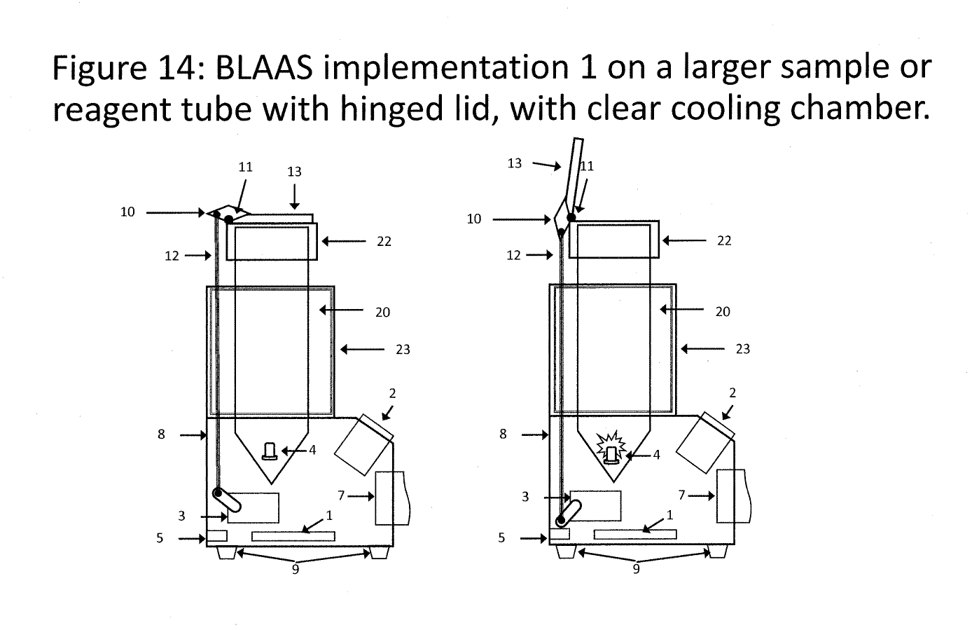

In another embodiment, heating or cooling techniques can be applied for optimal temperature, as shown in FIG. 14, inside a thermally isolated chamber (23) in which the tubes rest. This chamber can be configured with cooling or heating capabilities, and supports the tubes in position so no extra support bracket (21) is needed. To extract liquid from a tube, you need to see the liquid level, so the upper components holding the cooling or heating water are made from acrylic or polycarbonate or other clear components, with the LED illuminating the contents of the tube when the hinged lid has opened.

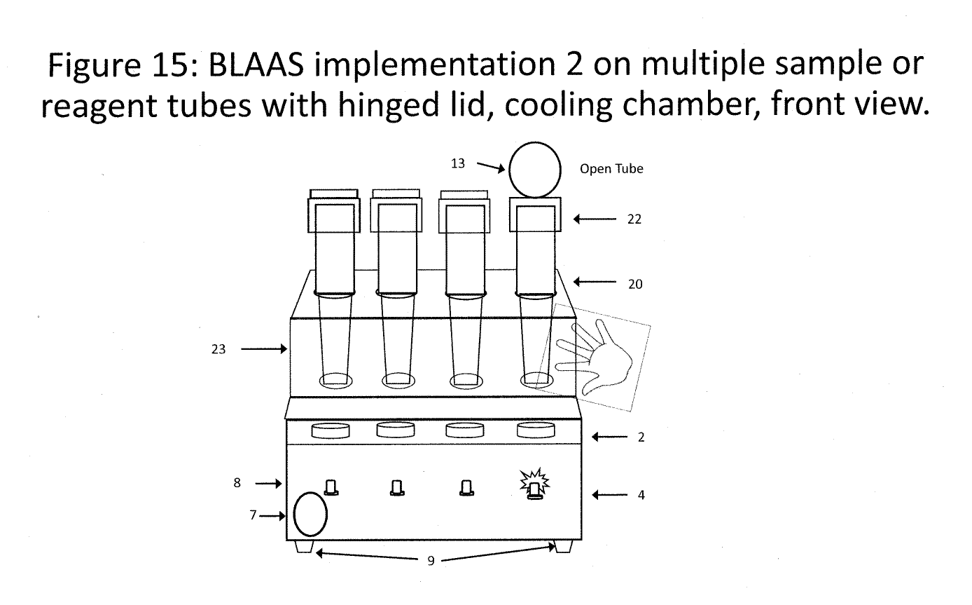

FIG. 15, shows a front view of multiple tubes in a BLAAS-enabled rack of four tubes with the thermally isolated chamber (23) in place. This can be configured with individual sensors at each tube position, allowing hands-free access to the content of the any of the individual tubes. Individual LED lights illuminate the contents of the tube which is triggered to open, as shown on the tube furthest to the right.

### A Benchtop Device Implementation for Waste Disposal

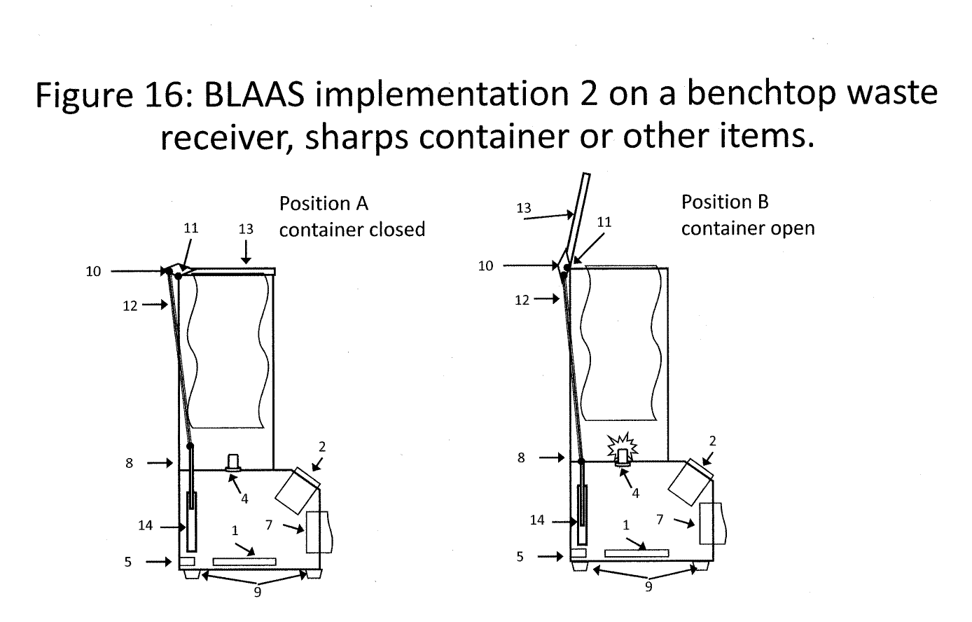

FIG. 16 shows another embodiment of BLAAS can open a container that is useful for bench waste items, sharps disposal or even dispensing clean pipettes or bulk sample tubes, pipet tips, or other needed benchtop item. A disposable plastic bag is shown inserted into the large opening for use as a waste receptacle. In this case, a linear actuator (14) is shown, but any mechanical actuator can be applied. Again, the right panel shows the device in the open state with LED illuminated.

### A Benchtop Implementation Without an External Casing

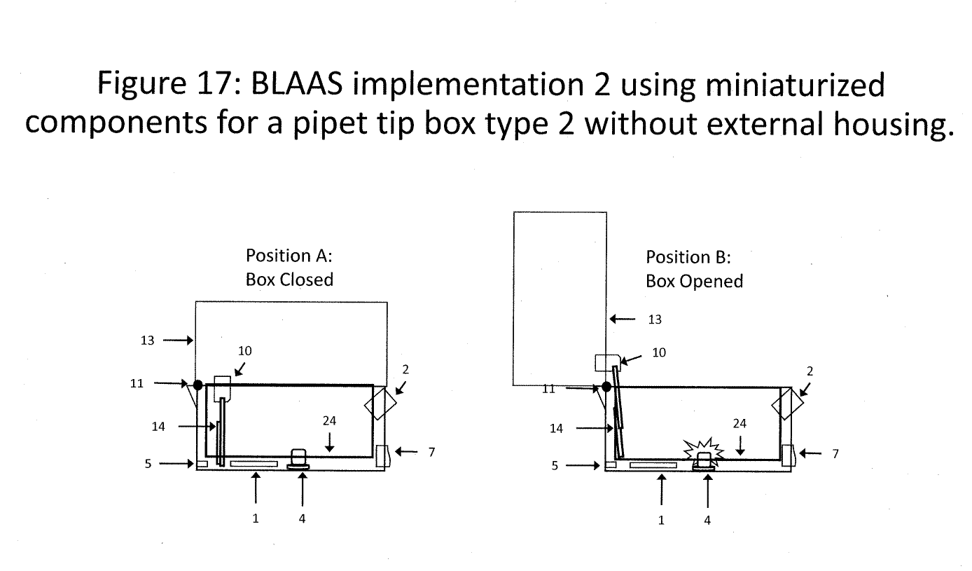

FIG. 17 shows the use of micro linear actuators and other miniaturized BLAAS components in a pipet tip box without an external housing. As custom components are designed and miniaturized their smaller size removes the need for a heavy external housing to mount the necessary parts, and allows them to be incorporated directly into modified housings of the benchtop apparatus directly. In this case, an extra inner liner (24) is installed to keep the items in the box clean, as some amount of air circulation is needed to keep the electrical components cool.

### A Multiplexing Benchtop Device Implementation

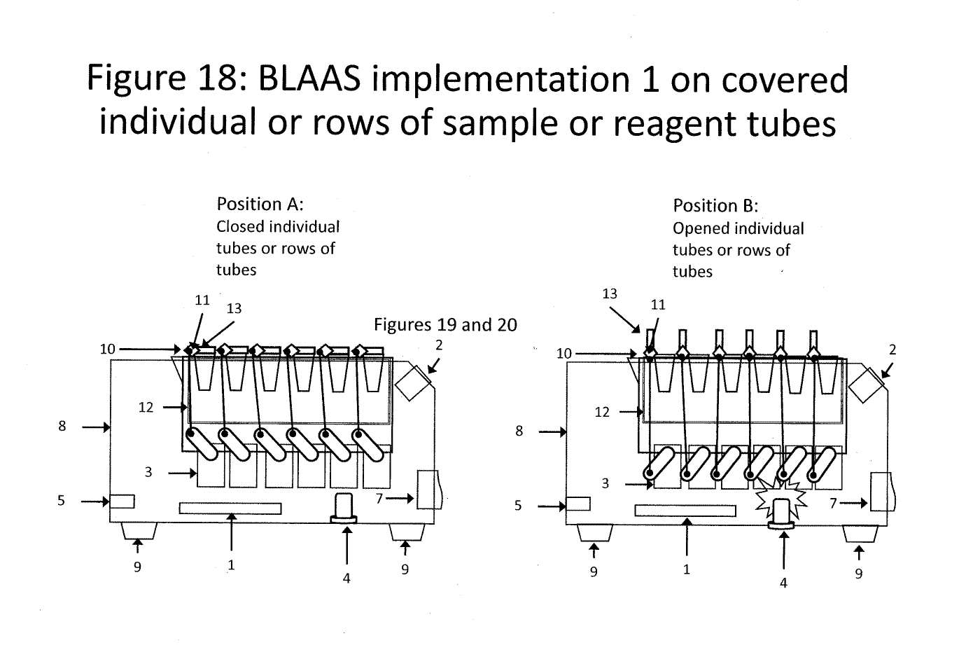

In certain embodiments, multiplexing BLAAS to control either rows of lids or even individual lids for multiple tube arrays as shown in FIG. 18 is an extension of the single BLAAS using multiple servos or linear actuators controlled by the microprocessor. Various schemes can be devised to control individual lids in sequence (each activation of the sensor opening the next tube in a defined series for instance) or by rows (if using an 8 channel pipettor for instance) across a wide range of tube volumes and numbers including 96 or 384 well plate formats (which is about the limit of manual pipetting) with temperature control as previously described.

### Double Action Servo Spring Mechanism

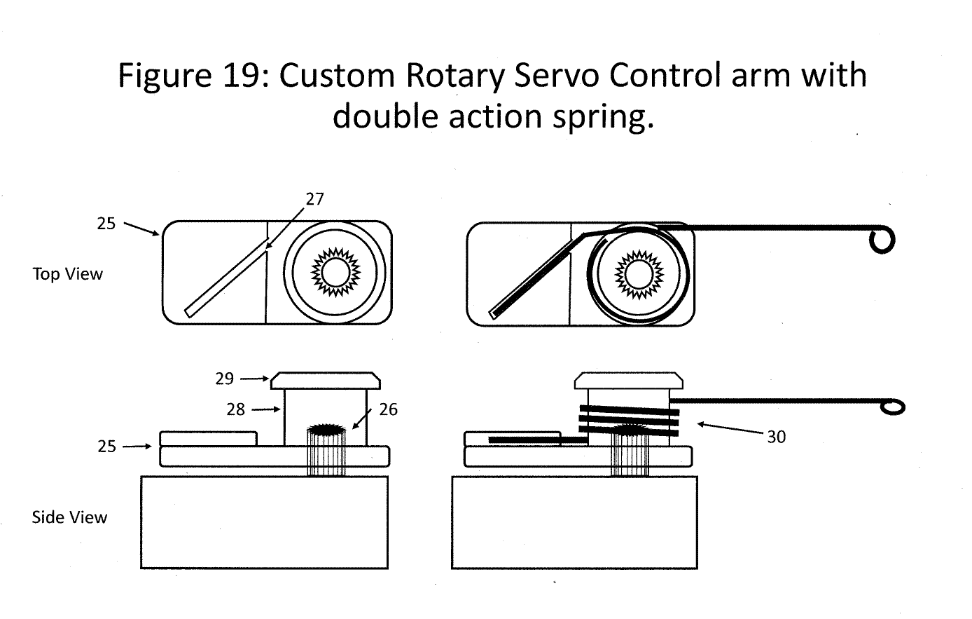

FIG. 19 shows the double action spring mechanism in the linkage assembly designed for the rotary servos and the linear actuators. It is composed of a custom manufactured rigid plastic device (25) which fits snugly on the output splines of a servo (26). This custom servo control arm has a groove in its base (27) to immobilize one arm of the spring, as well as a tubular extension (28) centered over the servo spline and a larger top to keep the spring in place (29). A coiled spring (30) is installed around the raised tubular section, with one arm in the groove and the other arm extending out, as shown in top and side views. Force is applied via a rotating motion of the servo at determined speeds to defined positions for smooth motion of the device. This coiled spring mechanism protects both the servo or linear actuator as well as the box top or tray cover or tube cover control horn from damage if its motion is obstructed or redirected in some way. In a practical sense, the lid can be manually opened at any time, even with the power off, without fear of damaging the linkage or actuator assembly or other components. If the lid begins to close while the operator is still using the device, it is easy to hold the top open manually until the operator is finished accessing the device. This general design can use a wide variety of springs with different tension ratings and coil sizes which can be mounted on a variety of servos with wide ranges in size and power, making it a versatile solution to innumerable applications.

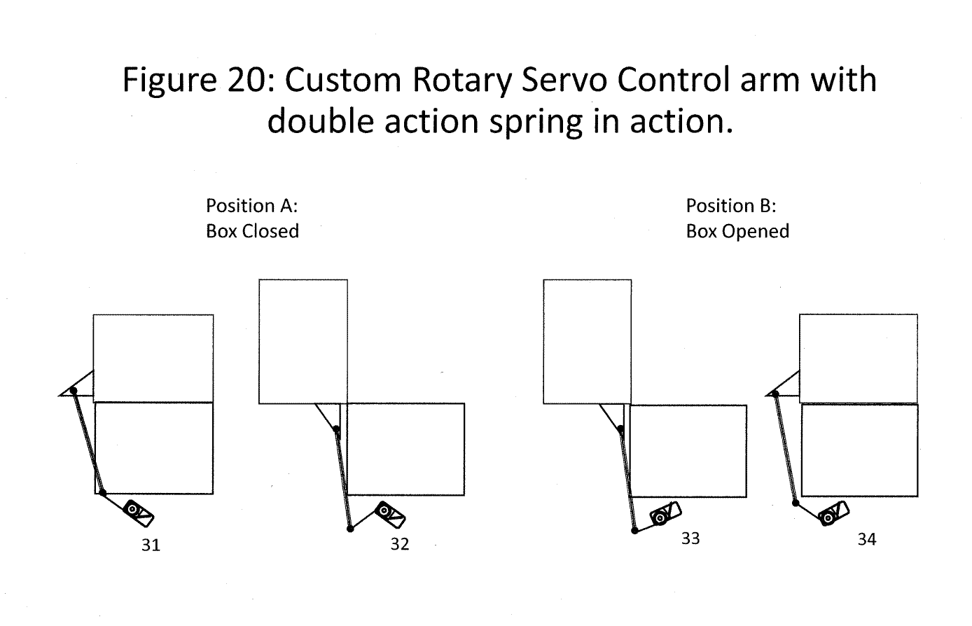

FIG. 20 shows on the furthest left of the figure (31), with the servo and box top in the closed position, the top can be manually opened, with the spring flexing to accommodate the motion applied as shown in the middle left drawing (32). Once manually opened, the box top returns readily to the original closed position when released. Likewise, in the two figures on the right side of the figure, when the servo and box lid are open (33), the lid can be closed manually without damaging the linkage assembly, as the spring flexes the other direction to accommodate this force (34).

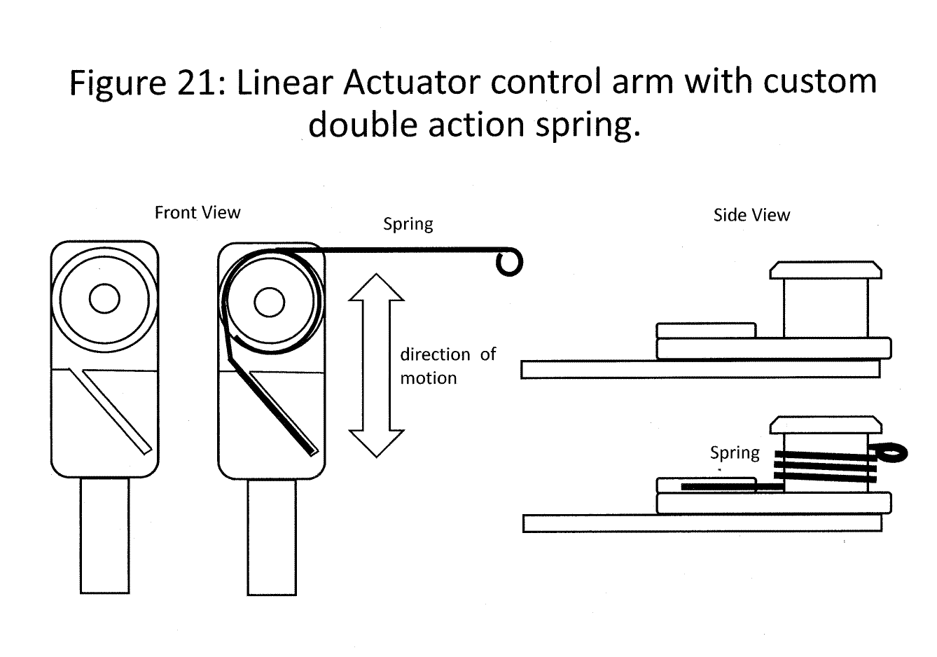

FIG. 21 shows another embodiment of the double action spring assembly mounted on the arm of a linear actuator, where it once again allows freedom of motion of the movable part regardless of the mechanical actuator position. In this case the force is applied in a linear manner, and the coiled spring accommodates the motion and forces in a very analogous manner to the rotating servo version.

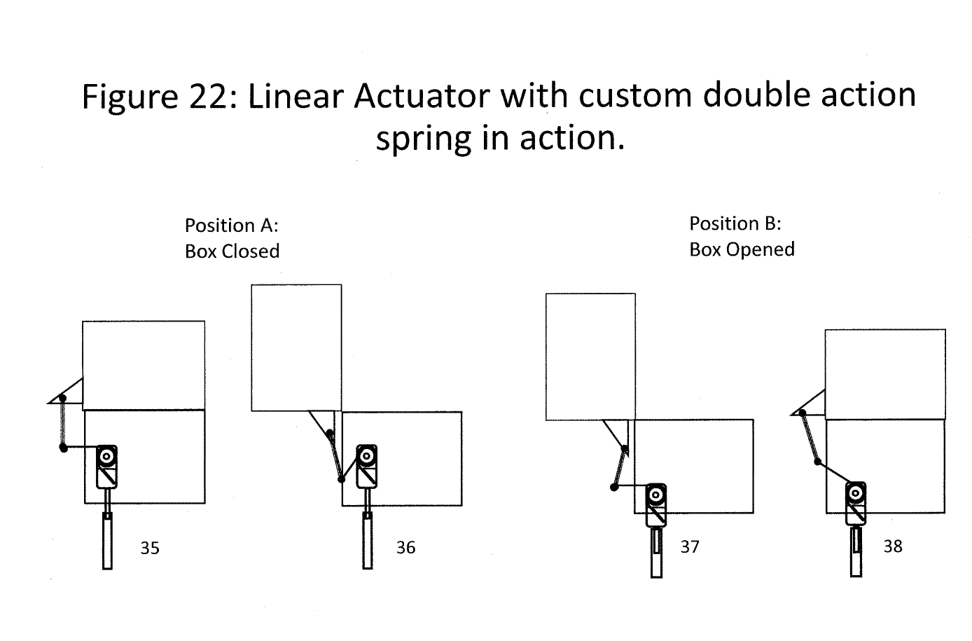

FIG. 22 shows the action of this custom double action spring on a linear actuator. On the furthest left of the figure (35), with the linear actuator and box top in the closed position, the top can be manually opened, with the spring flexing to accommodate the motion applied as shown in the middle left drawing (36). Once manually opened, the box top returns readily to the original closed position when released. Likewise, in the two figures on the right side of the figure, when the servo and box lid are open (37), the lid can be closed manually without damaging the linkage assembly, as the spring flexes the other direction to accommodate this force (38). If the lid begins to close while the operator is still using the device, it is easy to hold the top open manually until the operator is finished accessing the device.

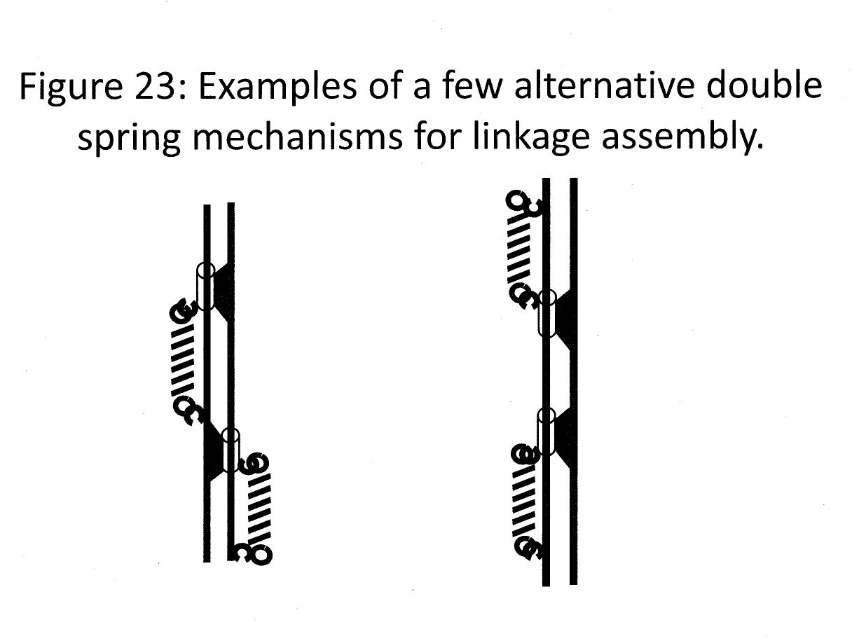

Various double spring mechanisms, like some of which are shown in FIG. 23, can be constructed that simulate the flexibility of the double action single spring mechanism described here. However, the design of the preferred embodiment of the double action single coiled spring discussed herein above has the advantage of simplicity as well as versatility.

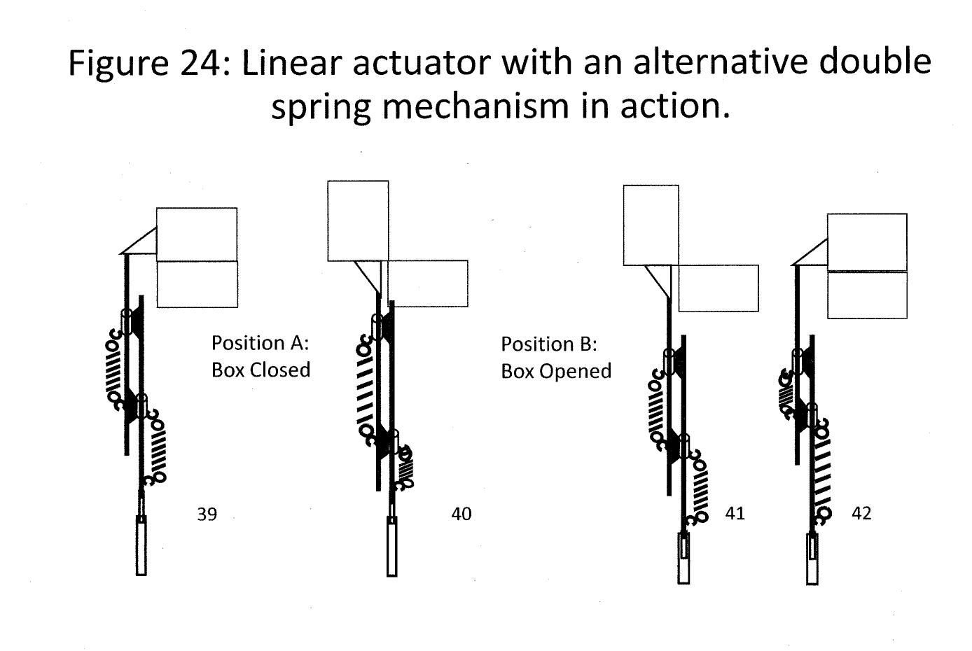

FIG. 24 shows the action of a double spring mechanism on a linear actuator. In a similar fashion to the custom rotary and linear double action spring mechanism, the furthest left of the FIG. 39), with the linear actuator and box top in the closed position, the top can be manually opened, with the spring flexing to accommodate the motion applied as shown in the middle left drawing (40). Once manually opened, the box top returns readily to the original closed position when released. Likewise, in the two figures on the right side, when the servo and box lid are open (41), the lid can be closed manually without damaging the linkage assembly, as the springs flex the other direction to accommodate this force (42). If the lid begins to close while the operator is still using the device, it is easy to hold the top open manually until the operator is finished accessing the device.

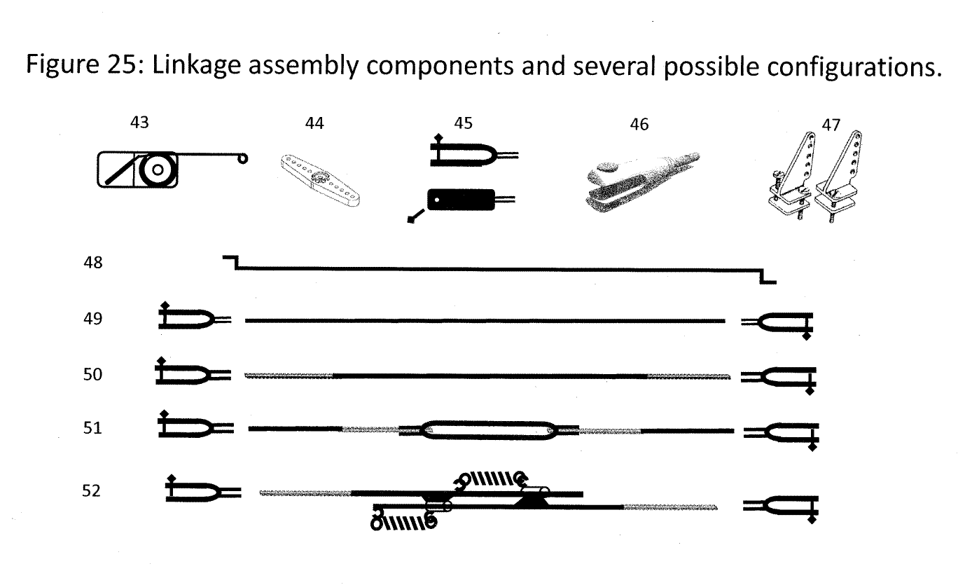

Connecting the servo, stepper motor (controlled with a stepper controller) or other linear actuator to the moving part of the device is a linkage assembly and various components, some examples of which are shown in FIG. 25. Components of the linkage assembly can include the custom servo arm with a double action spring (43), regular servo arms (44), clevis devices to connect to the servo arm (45 and 46) which allow a plane of rotation along the axis of rotation via a pin which passes through a hole in the servo arm or loop for the custom spring assembly, and a control horn (47) of some type to receive the force of the motion and translate it to the movable part of the device. The force is transmitted via a push rod of various lengths or material but typically metal, which can be as simple as a single rod with sharp perpendicular “Z” bends (48) which pass through the servo arm and control horn at a predetermined length. The addition of a clevis to the end instead of the bends (49) allow facile connection to the servo arm and control horn as needed, and threaded devises and push rods (50) allow for the length of the linkage to be adjusted by screwing the clevis one direction or the other along the rod as needed. The use of a turnbuckle and a normal and a reverse threaded rod (51) gives an easy method to quickly adjust the linkage assembly's length without having to disconnect devises from their control positions. The use of double springs on a linkage assembly (52) with threaded rods and devises (or the turnbuckle) makes a versatile and robust system which will protect the components from damage in almost any circumstance.

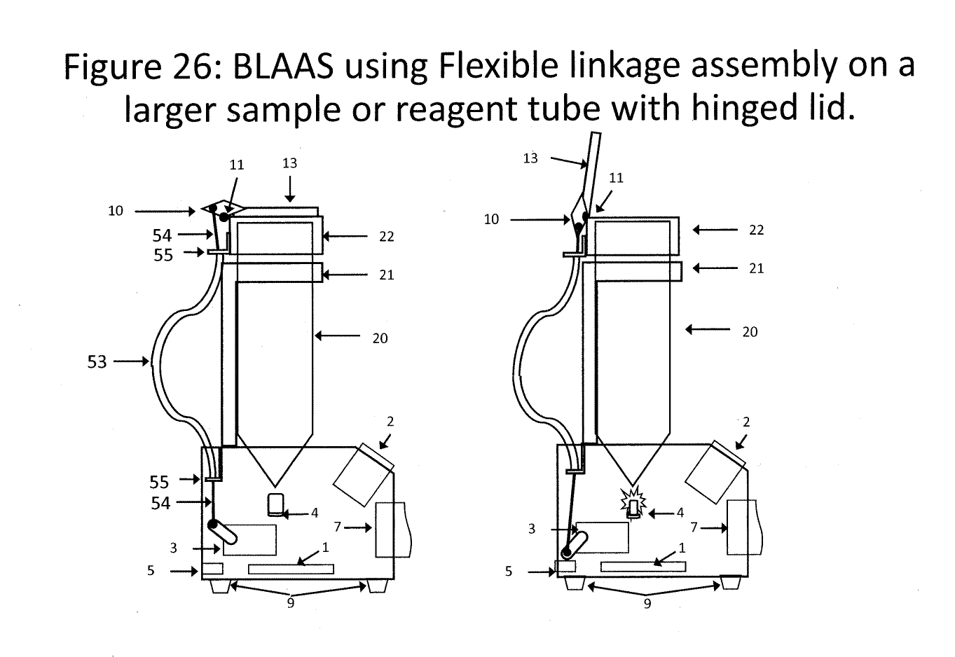

Another versatile linkage assembly can be constructed or commercially purchased as a flexible linkage, as shown in FIG. 26. This type of linkage allows the force of the servo or linear actuator to be transmitted relatively long distances and difficult angles by using a flexible outer tube (53) and a semi rigid push rod (54) to connect the servo to the control horn, typically using threaded devises and rods at each end. The ends of the flexible outer tube are held in position with brackets (55) at each end, and the entire linkage assembly is flexible, allowing the cap to be removed from the top of the tube a shown in the example figure and replaced on another size tube easily with no loss of functionality.

### A Benchtop Device Implementation Using Pneumatic Control

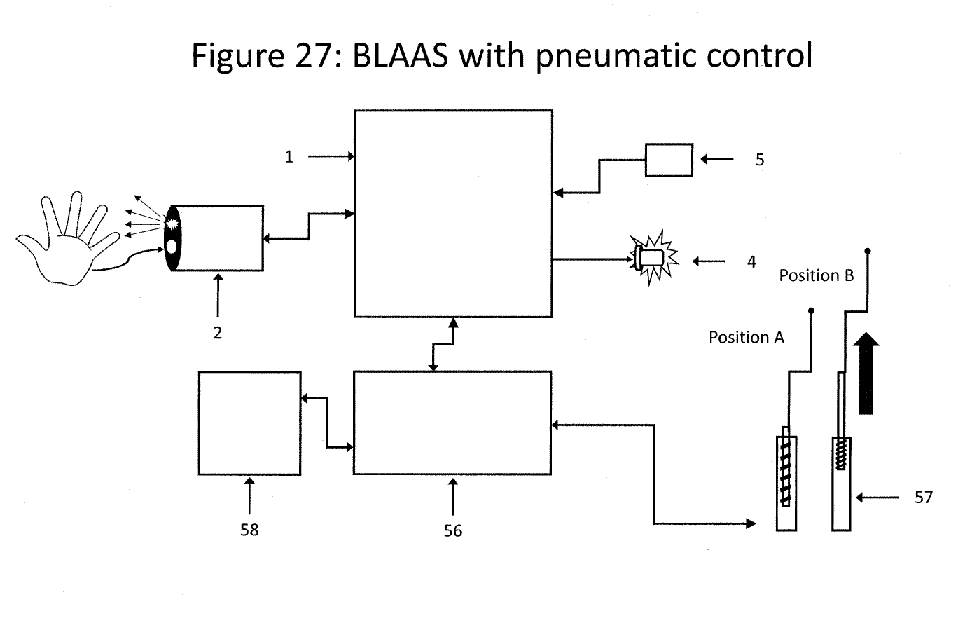

FIG. 27 shows the basic schematics for BLAAS using pneumatic control. The microprocessor (1) controls one or more solenoids on a vacuum or pressure manifold (56) which supplies vacuum or pressure to the pneumatic pistons (57) effectively causing motion to occur. Note that this type of system typically uses either vacuum or pressure supplied from an external source (58) to drive the piston in a direction, relying on a spring mechanism somewhere in the piston, linkage assembly or hinged top or cap assembly to return the system to the original position once the vacuum or pressure has been released. In the case shown in FIG. 22, pressure drives the piston upwards from Position A against a spring to Position B. When the pressure is released the spring returns the piston to Position A. Some advantages of pneumatically driven systems include a fewer number of mechanical parts to wear, smooth system operation and innate resistance to linkage damage as they system is controlled by air pressure and springs.

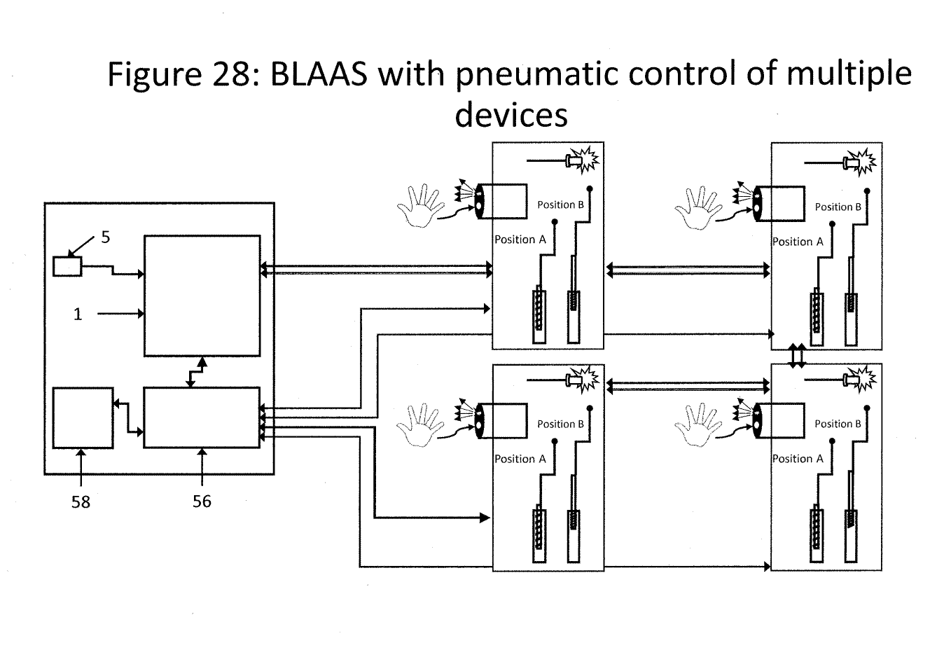

FIG. 28 shows another advantage to using pneumatic actuators is the ease of multiplexing many small pneumatic pistons to control arrays of tubes or containers of assorted sizes, numbers and configurations. Indeed, a single BLAAS system with pneumatic control could operate several devices in the same external housing or in different external housings from the same microprocessor and control manifold, with only a minimum amount of hardware installed in each individual device location. The vacuum or pressure manifold (56) can have many controllable solenoids which supply pressure or vacuum via individual tubes to the pneumatic pistons, while to electronic sensors and LED lights communicate directly to the microprocessor (1) (shown in double arrows).

### A Benchtop Device Implementation Using Magnetic Control

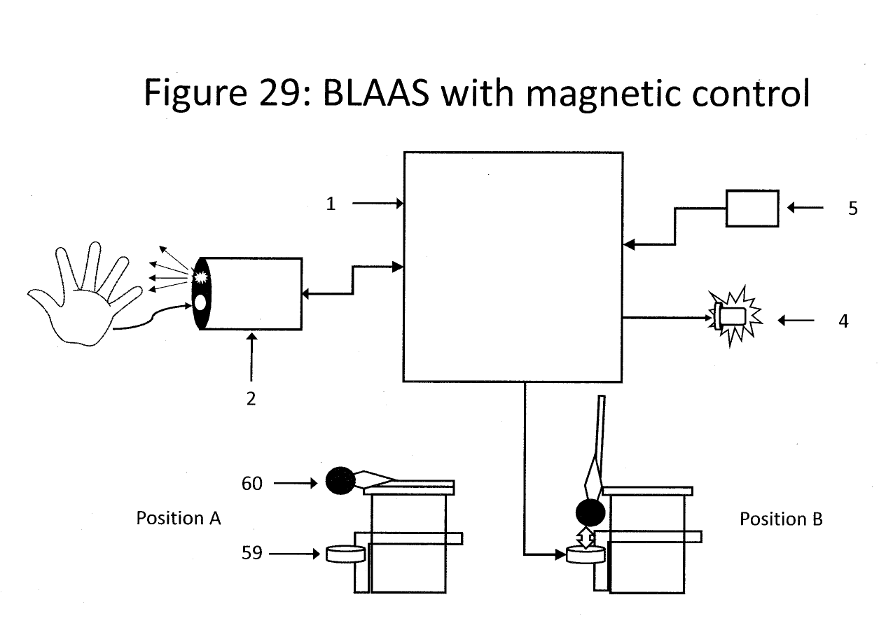

FIG. 29 shows a simple magnetic or electromagnetic mechanism to open the spring-loaded top of a reagent or sample tube. An electromagnet (59) is positioned near the hinged top of the tube. This top has a magnetic-attractive metal tab or extrusion (60) that moves towards the electromagnet when it is energized by the microprocessor (1), moving the hinge and opening the top of the tube. When the voltage is turned off by the microprocessor the spring-loaded top of the tube closes again.

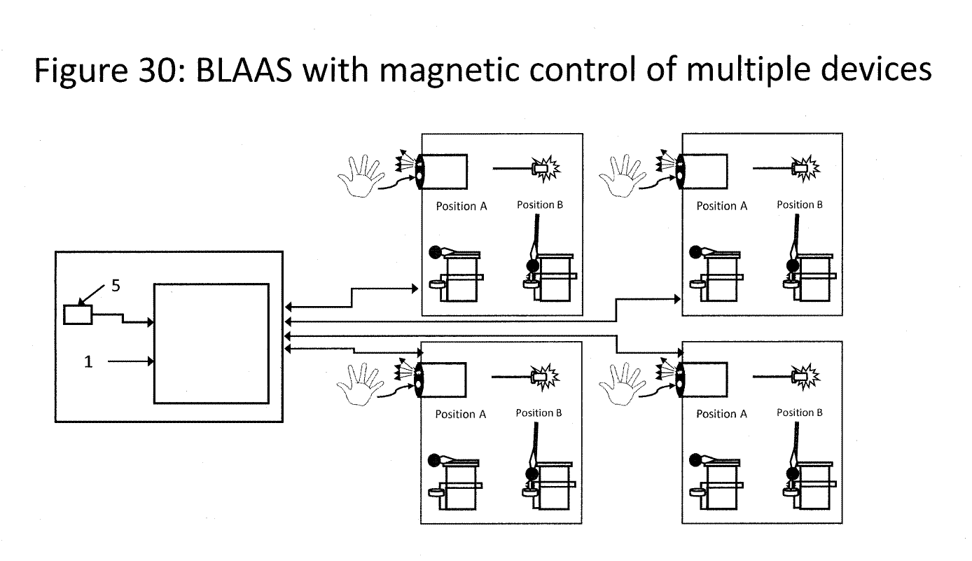

FIG. 30 shows BLAAS with multiple devices under electromagnetic control. This configuration can be descriptive of the BLAAS and multiple tubes in one device, or with the BLAAS controlling remote devices, each with one or more positions. One advantage of using magnetic attraction to move parts is the complete lack of any mechanical parts (servo, linkage assembly, spring assembly of instance) to wear and need replacing, other than the hinged top of the tubes in use, which are a consumable item and will need to be replaced regularly. Another advantage is the simplicity of the entire system, as the microprocessor needs no other components to control the entire process, unlike the pneumatic system previously described. One big advantage to magnetic control is the ability to miniaturize and multiplex the devices to open arrays of small tubes or even individual wells on a 96 or 384 well plate system. Using magnetics on smaller tubes and trays or racks of small tubes is preferred.

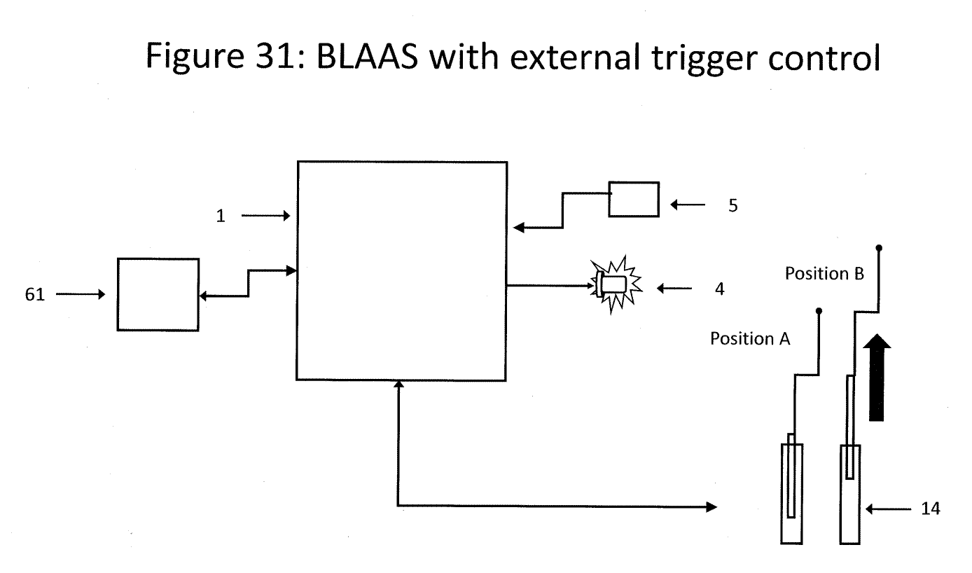

FIG. 31 shows BLAAS configured with an external trigger instead of the proximity sensor. In this case, the external trigger (61) is provided by another system of controlling electronics in able to open and close desktop components on demand for automated chemistry stations or robotic platforms. These chemistry stations use 3 axis arms equipped with various pipettors or other tools to automate benchtop workflows, and are very well integrated into many laboratories. The BLAAS can be configured to open multiple containers on a given workspace in this type of application.

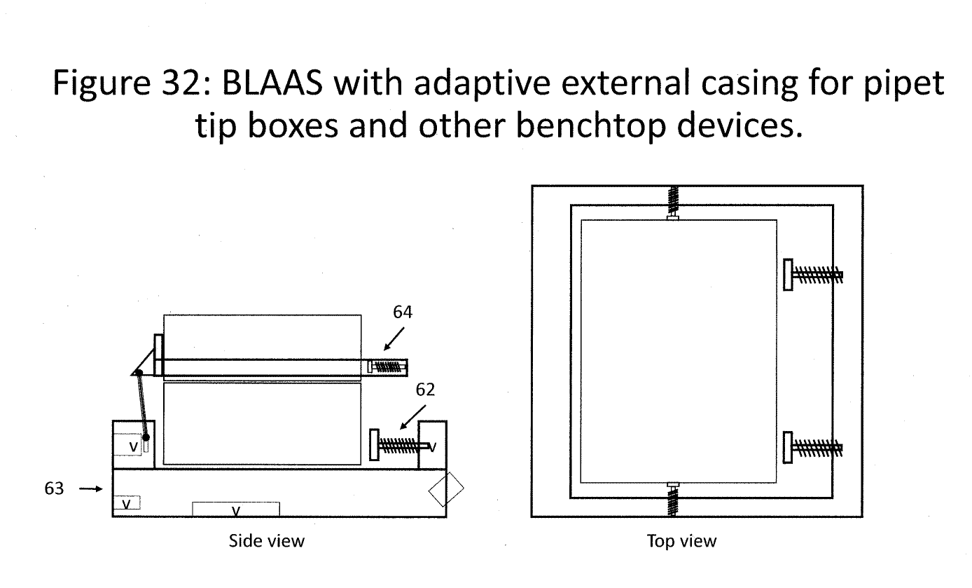

FIG. 32 shows BLAAS installed on an adaptive external housing or case which can accept a variety of shaped and sized devices. This example shows spring loaded cams or threaded screws (62) to hold the base of a box in place on the BLAAS housing (63), with a lid bracket (64) that holds the control horn in place. This device can hold a wide number of different benchtop device boxes, and will be very useful to adapt to the pipet tip boxes of many different manufacturer's pipet tip systems.

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A benchtop laboratory apparatus automated system comprising:
a benchtop laboratory apparatus with a cover, wherein the laboratory apparatus is connected to an automated system;
a power input into the automated system;
a programmable control board, wherein the programmable control board controls the automated system;
a sensor, wherein the sensor detects an operator's hand present near the apparatus;
a physical actuator, wherein the physical actuator shifts between a first position and second position;
a mechanical linkage, wherein the mechanical linkage links the shift in the physical actuator from the first position to the second position to the cover of the laboratory apparatus, and
further wherein in the first position the cover of the laboratory apparatus is closed and in the second position the cover of the laboratory apparatus is open; and
an electronic network, wherein the electronic network communicates between the sensor and the programmable control board and the physical actuator whenever the operator's hand is present near the apparatus,
and wherein when the programmable control board receives a communication from the sensor that the operator's hand is present near the apparatus then the programmable control board instructs the physical actuator to shift from the first position to the second position.

2. The automated system of claim 1, wherein the automated system further comprises:
an external case, wherein the automated system is integrated with the external case before and during operation of the automated system,
and further wherein the benchtop laboratory apparatus can be separately removed from the external case and the automated system.

3. The automated system of claim 1, wherein the automated system is integrated with the benchtop laboratory apparatus before and during operation of the automated system.

4. The automated system of claim 1, wherein the automated system further comprises:
a light source, wherein the light source illuminates during the operation of the automated system when the physical actuator shifts from the first position to the second position.

5. The automated system of claim 1, wherein the automated system further comprises:
a light source, wherein the light source illuminates the benchtop laboratory apparatus during the operation of the automated system when the physical actuator shifts from the first position to the second position.

6. The automated system of claim 2, wherein the automated system further comprises:
a light source, wherein the light source illuminates the benchtop laboratory apparatus during the operation of the automated system when the physical actuator shifts from the first position to the second position, and
further wherein the light source is positioned within the external case underneath the benchtop laboratory apparatus.

7. The automated system of claim 1, wherein the physical actuator is a rotary servo or a stepper motor, wherein the stepper motor is controlled by a stepper controller.

8. The automated system of claim 1, wherein the physical actuator is a linear actuator.

9. The automated system of claim 1, wherein the physical actuator is a pneumatic control.

10. The automated system of claim 1, wherein the physical actuator is a magnetic control.

11. The automated system of claim 1, wherein the mechanical linkage is a double action spring mechanism.

12. The automated system of claim 7, wherein the rotary servo is connected to a double action spring mechanism, and wherein the double action spring mechanism comprises:
a rigid plastic device, wherein the device fits onto the output splines of the rotary servo;
a servo control arm, wherein the servo control arm is formed by the fitted rigid plastic device, and
further wherein the servo control arm comprises a base containing a groove;
a coiled spring, wherein one arm of the spring is immobilized within the groove of the servo control arm and the other arm of the spring is extending out; and
a tubular extension centered over the rotary servo splines, wherein the tubular extension comprises a top that holds the coiled spring in place,
wherein the coiled spring is installed around the tubular extension.

13. The automated system of claim 1, wherein the benchtop laboratory apparatus is a refillable pipet tip box.

14. The automated system of claim 1, wherein the benchtop laboratory apparatus is a reagent tube.

15. The automated system of claim 1, wherein the benchtop laboratory apparatus is a waste disposal unit.

16. The automated system of claim 2, wherein the external case further comprises an inner thermal liner, wherein the thermal liner can either heat or cool the benchtop laboratory apparatus.

17. The automated system of claim 3, wherein the automated system further comprises an inner liner, wherein the inner liner permits air circulation within the benchtop laboratory apparatus.

18. A method of opening a benchtop laboratory apparatus using an automated system comprising the steps of:
sensing an operator's hand present near a sensor, wherein the sensor detects the presence of the operator's hand, and further wherein the sensor is part of an automated system comprising a benchtop laboratory apparatus with a cover;
communicating the presence of the operator's hand from the sensor to a programmable control board;
instructing a physical actuator to shift from a first position to a second position, wherein the physical actuator is instructed by the programmable control board after the sensor has communicated to the programmable control board the presence of the operator's hand;
shifting the physical actuator from a first position to a second position;
moving a mechanical linkage that is connected to the physical actuator, wherein the mechanical linkage physically transmits the shift from the first position to the second position to the cover of the benchtop laboratory apparatus; and
wherein the shift of the physical actuator from the first position to the second position corresponds to a shift from a closed cover to an open cover of the benchtop laboratory apparatus.

19. The method of claim 18, further comprising the step of:
instructing the physical actuator to shift from the second position back to the first position after a period of time when the sensor no longer detects the presence of the operator's hand.

20. The method of claim 19, further comprising the step of:
illuminating the benchtop laboratory apparatus during the shift from the first position to the second position, and
wherein the illumination is maintained until the physical actuator is instructed to shift from the second position back to the first position.
